(19) United States
(12) Patent Application Publication
(10) Pub. No.: US 2015/0026275 A1
(43) Pub. Date: Jan. 22, 2015

(54) CONTENT SHARING METHOD, TERMINAL, SERVER, AND SYSTEM, AND COMPUTER STORAGE MEDIUM

(71) Applicant: TENCENT TECHNOLOGY (SHENZHEN) COMPANY LIMITED, Shenzhen City (CN)

(72) Inventor: Xiaolong Zhang, Shenzhen (CN)

(21) Appl. No.: 14/383,882

(22) PCT Filed: Mar. 1, 2013
(86) PCT No.: PCT/CN2013/072046

§ 371 Date: Sep. 8, 2014

(30) Foreign Application Priority Data
Mar. 8, 2012 (CN) 201210059860.3

(51) Int. Cl. H04W 4/02; H04L 29/08; H04L 12/58

(52) U.S. Cl. CPC H04W 4/025; H04L 51/08; H04L 67/22
USPC 709/206

(57) ABSTRACT

A method, a terminal, a server, a system and a computer storage medium for sharing contents are disclosed. The method includes: receiving a reporting request massage carrying position information and identifier information of a user sent by a terminal when an application adapted to obtain contents is used to obtain a content to be shared, obtaining a sharing object according to the position information and the identifier information of the user, wherein the distance between the user and the sharing object is less than a predetermined distance and/or the sharing object has used the application in a predetermined time period, and sending a reporting response massage carrying the sharing object to the terminal to enable the terminal to share the content to be shared according to the sharing object.

### CROSS-REFERENCE TO RELATED APPLICATIONS

This application is the U.S. National Phase application of PCT International Application No. PCT/CN2013/072046, filed Mar. 1, 2013, and claims priority of Chinese Patent Application No. 201210059860.3, filed Mar. 8, 2012, the disclosures of both of which are incorporated herein be reference in their entireties for all purposes.

### TECHNICAL FIELD

The present invention relates to a field of communication technology, and particularly to a method, a terminal, a server, a system and a computer storage medium for sharing contents.

### BACKGROUND

With the rapid development of mobile terminal technology, more and more applications are used in a mobile terminal. For example, an application for taking photos in the mobile terminal is one kind of applications which can be used in the mobile terminal.

Nowadays, users often use applications for taking photos installed in the mobile terminal to take photos, and then manually select identifier information of one or more users from a user list in the mobile terminal, take the selected identifier information as a sharing object, and send the taken photos to the sharing object by services such as Email, Multimedia massage, or MicroBlog, thereby sharing the photos with the sharing object.

The technology known in the art has at least the following problems:

The user has to manually select sharing objects.

### SUMMARY OF THE INVENTION

A method for sharing contents includes:

obtaining position information of a user, wherein the position information of the user is obtained when an application adapted to obtain contents is used to obtain a content to be shared;

obtaining a sharing object from a position server according to the position information and identifier information of the user, wherein the distance between the user and the sharing object is less than a predetermined distance and/or the sharing object has used the application in a predetermined time period; and

sharing the content to be shared according to the sharing object.

A method for sharing contents includes:

receiving a reporting request massage sent by a terminal when the terminal uses an application adapted to obtain contents to obtain a content to be shared, wherein the reporting request massage carries position information and identifier information of the user;

obtaining a sharing object according to the position information and the identifier information of the user, wherein the distance between the user and the sharing object is less than a predetermined distance and/or the sharing object has used the application in a predetermined time period; and

sending a reporting response massage carrying the sharing object to the terminal to enable the terminal to share the content to be shared according to the sharing object.

A terminal includes:

a first obtaining module, adapted for obtaining position information of a user when an application adapted to obtain contents is used to obtain a content to be shared;

a second obtaining module, adapted for obtaining the sharing object from a position server according to the position information of the user and the identifier information of the user, wherein the distance between the user and the sharing object is less than a predetermined distance and/or the sharing object has used the application in a predetermined time period; and

a sharing module, adapted for sharing the content to be shared according to the sharing object.

A position server includes:

a receiving module, adapted for receiving a reporting request massage sent by a terminal when the terminal uses an application adapted to obtain contents to obtain a content to be shared, wherein the reporting request massage carries position information and identifier information of the user;

a third obtaining module, adapted for obtaining a sharing object according to the position information and identifier information of the user, wherein the distance between the user and the sharing object is less than a predetermined distance and/or the sharing object has used this application in a predetermined time period; and

a sending module, adapted for sending a reporting response massage carrying the sharing object to the terminal to enable the terminal to share the content to be shared according to the sharing object.

A system for sharing contents includes the terminal and the position server described above.

One or more computer storage mediums include computer-executable instructions, and the computer executable instructions are adapted to perform the method for sharing contents.

### BRIEF DESCRIPTION OF ACCOMPANYING DRAWINGS

FIG. 1 illustrates a flow chart of a method for sharing contents according to Embodiment 1 of the present invention.

FIG. 2 illustrates a flow chart of a method for sharing contents according to Embodiment 2 of the present invention.

FIG. 3 is illustrates a flow chart of a method for sharing contents according to Embodiment 3 of the present invention.

FIG. 4 illustrates a structure diagram of a terminal according to Embodiment 4 of the present invention.

FIG. 5 illustrates a structure diagram of a position server according to Embodiment 5 of the present invention.

FIG. 6 illustrates a structure diagram of a system for sharing contents according to Embodiment 6 of the present invention.

### DETAILED DESCRIPTION

To make the object, technical solution and advantages of the present invention more apparent, the embodiments of the present invention will be further described in detail by reference to the accompanying drawings.

### Embodiment 1

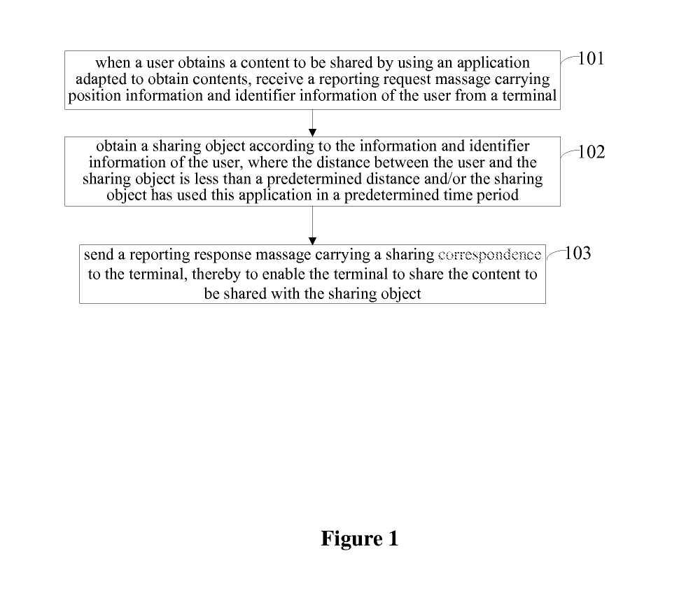

As shown in FIG. 1, an embodiment of the present invention provides a method for sharing contents, which includes the following:

Step 101: when a user uses an application adapted to obtain contents to obtain a content to be shared, receiving a reporting request massage which carries position information and identifier information of the user from a terminal of the user.

Step 102: obtaining sharing object(s) according to the position information and identifier information of the user, where the distance between the user and any of the sharing object(s) is less than a predetermined distance and/or any of the sharing object(s) has used this application in a predetermined time period.

Step 103: sending a reporting response massage carrying a sharing object to the terminal, thereby to enable the terminal to share the content to be shared with the sharing object(s).

The executive entity in this embodiment may be a position server.

In the embodiment of the present invention, a reporting request massage is received from a terminal, sharing object(s) is obtained according to the position information and identifier information of a user carried in the reporting request massage, where the distance between the user and any of the sharing object(s) is less than a predetermined distance and/or any of the sharing object(s) has used this application in a predetermined time period, and a reporting response massage is sent to the terminal to enable the terminal to share the content to be shared with the sharing object(s). In the embodiment, the distance between the user and any of the sharing object(s) is less than the predetermined distance, and both of the sharing object(s) and the user have used the application in a predetermined time period to obtain the content, thereby improving the interactivity between the user and the sharing object(s). In addition, the object list can be automatically obtained for the user so as to facilitate the user's operation.

### Embodiment 2

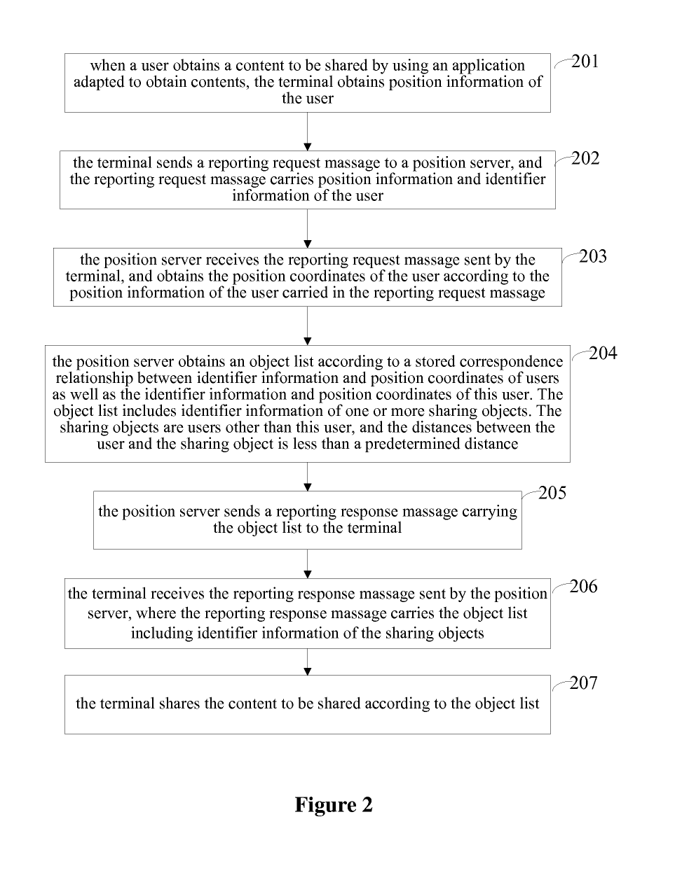

As shown in FIG. 2, an embodiment of the present invention provides a method for sharing contents, which includes the followings:

Step 201: when a user uses an application adapted to obtain contents to obtain a content to be shared, a terminal obtains position information of the user.

Specifically, the terminal may obtain the position information of the user by any one of the following three methods:

In the first method, the terminal obtains position coordinates of the position where the terminal is located by using a Global Positioning System (GPS) module included in this terminal to position this terminal, and takes the position coordinates as the position information of the user.

In this method, the position coordinates may be geographic coordinates or the like.

In the second method, the terminal obtains identifier information of a base station to which the terminal accesses, and uses the identifier information of the base station to which the terminal accesses as the position information of the user.

In this method, the identifier information of the base station may be an address or a serial number of the base station.

In the third method, the terminal obtains identifier information of a wireless fidelity (wifi) network to which the terminal access, and uses the identifier information of the wifi network to which the terminal access as the position information of the user.

In this method, the wifi network is also known as a wireless broadband, and the identifier information of the wifi network may be a MAC address or the like of the wifi network.

In the above methods, the terminal includes an application adapted to obtain contents, and the user may start the application adapted to obtain the contents in the terminal, and then obtain the content to be shared by starting this application adapted to obtain the contents in the terminal.

In the above methods, the application adapted to obtain the contents may be an application for taking photos, MicoBlog or the like in the terminal, and the content to be shared may be picture(s) or text(s).

For example, in this embodiment, an application for taking photos is taken an example, but the present invention is not limited thereto. When the content to be shared by the user are picture(s), the user can starts the application adapted to take photos in the terminal to obtain the picture(s) to be shared, then the terminal positions itself by using a GPS module included therein to obtain its position coordinates (3, 3) and takes its position coordinates (3, 3) as the position information of the user.

Step 202: the terminal sends a reporting request massage to a position server, and the reporting request massage carries the position information and identifier information of the user.

In this step, the identifier information of the user may be presorted in the terminal, thus the terminal may directly obtain the stored identifier information of the user, or the terminal may directly receive the identifier information of the user input by the user, and then, the terminal sends the reporting request massage carrying the position information and the identifier information of the user.

For example, the terminal sends the reporting request massage to the position server, and the reporting request massage carries the position information (3, 3) and the identifier information ID1 of the user.

Step 203: the position server receives the reporting request massage sent by the terminal, and obtains the position coordinates of the user according to the position information of the user carried in the reporting request massage.

Specifically, if the position information of the user carried in the reporting request massage is the position coordinates of the terminal, the position server determines that the position coordinates of the terminal carried in the reporting request massage is the position coordinates of the user.

If the position information of the user carried in the reporting request massage is the identifier information of the base station to which the terminal accesses, the position server obtains the position coordinates of the base station to which the terminal accesses from a correspondence relationship between stored identifier information and position coordinates of base stations according to the identifier information of the base station to which the terminal accesses, and takes the position coordinates of the base station to which the terminal accesses as the position coordinates of the user.

If the position information of the user carried in the reporting request massage is the identifier information of the wifi network to which the terminal access, the position server obtains the position coordinates of the wifi network to which the terminal access from a a correspondence relationship between stored identifier information and the position coordinates of wifi networks according to the identifier information of the wifi network to which the terminal accesses, and takes the position coordinates of the wifi network to which the terminal access as the position coordinates of the user.

For example, the position server receives the reporting request massage sent by the terminal, and the reporting request massage carries the position information (3, 3) and the identifier information ID1 of the user. Since the position information of the user is the position coordinates of the terminal, it is determined that the position coordinates of the user is (3, 3).

Step 204: the position server obtains an object list according to a stored correspondence relationship between identify information and the position coordinates of users as well as the identify information of this user and the position coordinates of this user. The object list includes identifier information of one or more sharing objects. The sharing object(s) are user(s) other than this user, and the distance between this user and any of the sharing object(s) is less than a predetermined distance.

Specifically, the position server determines a region by taking a point corresponding to the position coordinates of the user as a center and taking a predetermined distance as a radius, and obtains the identifier information of the user(s) in this region from the stored correspondence relationship between the identifier information and the position coordinates of users. If the identifier information of the user(s) in this region includes the identifier information of this user, the identifier information of this user is removed from the identifier information of the user(s) in this region, and the remaining identifier information of the user(s) in this region is taken as the identifier information of the sharing object(s). If the identifier information of the user(s) in this region does not include the identifier information of this user, the identifier information of the user(s) in this region is taken as the identifier information of the sharing object(s). The object list is formed by the identifier information of the sharing object(s).

Or, the following is performed. According to the position coordinates of the user and the correspondence relationship of the stored identifier information and position coordinates of users, the position server calculates the distance between this user and each of the users indicated in the correspondence relationship of the stored identifier information and position coordinates of the users, and obtains identifier information of the user(s) the distance between which and this user is less than a predetermined distance. If the identifier information of the user(s) in this region includes the identifier information of this user, the identifier information of this user is removed from the identifier information of the user(s) in this region, and the remaining identifier information of the user(s) in this region is taken as the identifier information of the sharing object(s). If the identifier information of the user(s) in this region does not include the identifier information of this user, the identifier information of the user(s) in this region is taken as the identifier information of the sharing object(s). The object list is formed by the identifier information of the sharing object(s).

Further, usage time when the sharing object(s) in the object list uses the application adapted to obtain contents lately is obtained, and identifier information of the sharing object(s) in the object list that has not used the application adapted to obtain the contents for a predetermined time period is removed according to the usage time. In such a way, the object list only includes the sharing object(s) that has used the application adapted to obtain the contents within the predetermined time period.

Specifically, the usage time when the sharing object(s) in the object list uses the application adapted to obtain contents lately is obtain according to a correspondence relationship between the stored identifier information and the usage time of users, and identifier information of the sharing object(s) in the object list that has not used the application adapted to obtain the contents for a predetermined time period is removed according to the usage time.

Further, a correspondence relationship between the identifier information and position coordinates of the user is established. Specifically, look up the stored correspondence relationship between the identifier information and position coordinates of users according to the identifier information of the user. If the position coordinates corresponding to the identifier information of the user are found, the found position coordinates are updated to the latest position coordinates of the user. If the position coordinates corresponding to the identifier information of the user are not found, the correspondence between the identifier information and the position coordinates of the user is taken as a record recorded in the correspondence relationship between the identifier information and position coordinates of users.

Further, the usage time when the user uses the application adapted to obtain contents lately is obtained, and a correspondence relationship between the identifier information of the user and the usage time thereof is established. Specifically, determine the current time as the usage time when the user uses the application adapted to obtain contents lately, and look up the correspondence relationship between the identifier information and the usage time of users according to the identifier information of the user. If the usage time corresponding to the identifier information of the user is found, the found usage time is updated to the latest usage time when the user uses the application. If the usage time corresponding to the identifier information of the user is not found, the correspondence relationship between the identifier information and the usage time of the user is taken as a record recorded in the correspondence relationship between the identifier information and usage time of users.

Further, a friend list of this user is obtained, where the friend list includes identifier information of user(s) who has a friend relationship with this user, and the identifier information of the user(s) who do not have a friend relationship with this user is removed from the object list according to the friend list of this user.

Specifically, the friend list of this user is obtained from a stored correspondence relationship between the identifier information and the friend lists of users according to the identifier information of this user, and the identifier information of the user(s) who do not have a friend relationship with this user is removed from the object list according to the identifier information of user(s) who has a friend relationship with this user in the friend list.

For example, in this embodiment, the position server includes a correspondence relationship between the identifier information and the position coordinates of users as shown in Table 1, and a correspondence relationship between the identifier information of and the usage time of users as shown in Table 2. The usage time of each user included in the correspondence relationship between the identifier information and the usage time of users shown in Table 2 is the time when each user uses the application adapted to take photos lately, i.e. the time when each user takes photos lately.

TABLE 1

| Identifier information of users | position coordinates |
|---|---|
| ID1 | (2, 2) |
| ID2 | (2, 3) |
| ID3 | (4, 4) |
| ID4 | (3, 4) |
| ID5 | (8, 8) |
| . . . | . . . |

TABLE 2

| Identifier information of users | Usage time |
|---|---|
| ID1 | Time1 |
| ID2 | Time2 |
| ID3 | Time3 |
| ID4 | Time4 |
| ID5 | Time5 |
| . . . | . . . |

The position server determines a region by taking a point with the position coordinates (3, 3) of the user as a center and taking a predetermined distance 3 as a radius, obtains the identifier information ID1, ID2, ID3 and ID4 of the users in this region from the stored correspondence relationship between the identifier information and the position coordinates of users as shown in Table 1, removes the identifier information ID1 of this user from the obtained identifier information ID1, ID2, ID3 and ID4 of the users, takes the remaining identifier information ID2, ID3 and ID4 of the users as the identifier information of the sharing objects, and forms an object list. According to the identifier information ID2, ID3 and ID4 of the sharing objects included in the object list, the position server finds from the correspondence relationship between the identifier information and the usage time of users shown in Table 2 that the usage time when the sharing object corresponding to the identifier information ID2 lately uses the application adapted to take photos is Time 2, the usage time when the sharing object corresponding to the identifier information ID3 lately uses the application adapted to take photos is Time 3, and the usage time when the sharing object corresponding to the identifier information ID4 lately uses the application adapted to take photos is Time 4. The time interval between the current time and any of Time 2 and Time 3 is less than a predetermined time, and the time interval between Time 4 and the current time is greater than the predetermined time. Therefore, the sharing object corresponding to the identifier information ID2 and the sharing object corresponding to the identifier information ID3 have used the application adapted to take photos within the predetermined time, while the sharing object corresponding to the identifier information ID4 has not used application adapted to take photos within the predetermined time. Thus, according to the usage time, the identifier information ID4 corresponding to the sharing object which has not used the application adapted to take photos within the predetermined time is removed from the object list. As a result, the final object list includes the identifier information ID2 and ID3 of the sharing objects.

The position server finds from the correspondence relationship between the identifier information and the position coordinates of users shown in Table 1 according to the identifier information ID1 of this user that the position coordinates corresponding to the identifier information ID1 is (2, 2), updates the position coordinates (2, 2) found in Table 1 to the latest position coordinates (3, 3) of this user, and obtains the correspondence relationship between the identifier information and the position coordinate of users as shown in Table 3.

TABLE 3

| Identifier information of users | position coordinates |
|---|---|
| ID1 | (3, 3) |
| ID2 | (2, 3) |
| ID3 | (4, 4) |
| ID4 | (3, 4) |
| ID5 | (8, 8) |
| . . . | . . . |

Further, the position server determines the current time Time 0 as the usage time when this user uses the application adapted to take photos lately, finds out from the correspondence relationship between the identifier information usage time of users shown in Table 2 according to the identifier information ID1 of this user that the usage time corresponding to the identifier information ID1 is Time 1, updates the usage time Time 1 found in Table 2 to the latest usage time Time 0 of this user, and obtains the correspondence relationship between the identifier information and the usage time of users as shown in Table 4.

TABLE 4

| Identifier information of users | Usage time |
|---|---|
| ID1 | Time0 |
| ID2 | Time2 |
| ID3 | Time3 |
| ID4 | Time4 |
| ID5 | Time5 |
| . . . | . . . |

Step 205: the position server sends a reporting response massage to the terminal, and the reporting response massage carries the object list.

Step 206: the terminal receives the reporting response massage sent by the position server, where the reporting response massage carries the object list and the object list includes identifier information of the sharing object(s).

In a process that the terminal uses the application adapted to obtain contents in order to obtain a content to be shared, the terminal may periodically perform the above Steps 202 to 206.

For example, the position server sends a reporting response massage to the terminal, the terminal receives this reporting response massage, where the reporting response massage carries an object list which includes the identifier information ID2 and ID3 of the sharing objects.

After the terminal obtains the content to be shared, the following Step 207 may be performed.

Step 207: the terminal shares the content to be shared according to the object list.

Specifically, the terminal displays the object list including the identifier information of the sharing object(s) to this user. If this user selects identifier information of a sharing object to be deleted from the object list, the terminal deletes from the object list the identifier information of the sharing objects selected by the user, and if this user needs to add identifier information of a new sharing object into the object list, the terminal obtains the identifier information of the new sharing object to be added and adds the identifier information of the new sharing object to be added into the object list. The terminal shares the content to be shared with the corresponding user(s) according to the identifier information of the user(s) included in the object list.

The terminal includes a user list which includes identifier information of one or more users, and the user may select identifier information of one or more users from the user list and take the selected identifier information as the identifier information of the new sharing object to be added. Correspondingly, the terminal may obtains from the user list the identifier information of the new sharing object to be added selected by the user.

In above procedure, the user may issue a sharing command to the terminal, and when the terminal receives the sharing command issued by the user, the terminal shares the content to be shared with the corresponding sharing object(s) according to the identifier information of the sharing object(s) included in the object list.

The operation that the terminal shares the content to be shared may specifically include any of the following methods:

In the first method, the terminal sends the content to be shared to the sharing object(s) corresponding to the identifier information of the sharing object(s) included in the object list, thereby sharing the content to be shared.

In the second method, the terminal sends the content to be shared and the object list to a sharing server, the sharing server stores the content to be shared and allocates link information for the content to be shared, sends the link information for the content to be shared to the sharing object(s) corresponding to the identifier information of the sharing object(s) included in the object list, thereby sharing the content to be shared.

In the above second method, when any of the sharing object(s) receives the link information for the content to be shared, the sharing object may obtain the content to be shared from the sharing server according to the link information for the content to be shared.

For example, supposing that the user neither needs to add identifier information of any new sharing object into the object list, nor needs to delete identifier information of any sharing object from the object list, when the terminal obtains a picture to be shared and receives a sharing command issued by this user, the terminal shares the picture to be shared according to the identifier information ID2 and ID3 of the sharing objects included in the object list.

In this embodiment of the present invention, the terminal obtains position information of this user, sends a reporting request massage carrying the position information and identifier information of this user to a position server, and the position server obtains a object list according to the position information and identifier information of this user carried in the reporting request massage. The object list includes sharing object(s), where the sharing object(s) are the user(s) other than this user, and the distance between the user and any of the sharing object(s) is less than a predetermined distance and/or any of the sharing object(s) has used this application in a predetermined time period. The position server sends a reporting response massage carrying the object list to the terminal to enable the terminal to share the content to be shared according to the object list. In this embodiment, the distance between the user and the sharing object is less than the predetermined distance, and both of the sharing object and the user have used this application in a predetermined time period to obtain the contents, thereby improving the interactivity between the user and the sharing object. In addition, the object list may be automatically obtained for the user in order to facilitate the user's operation.

### Embodiment 3

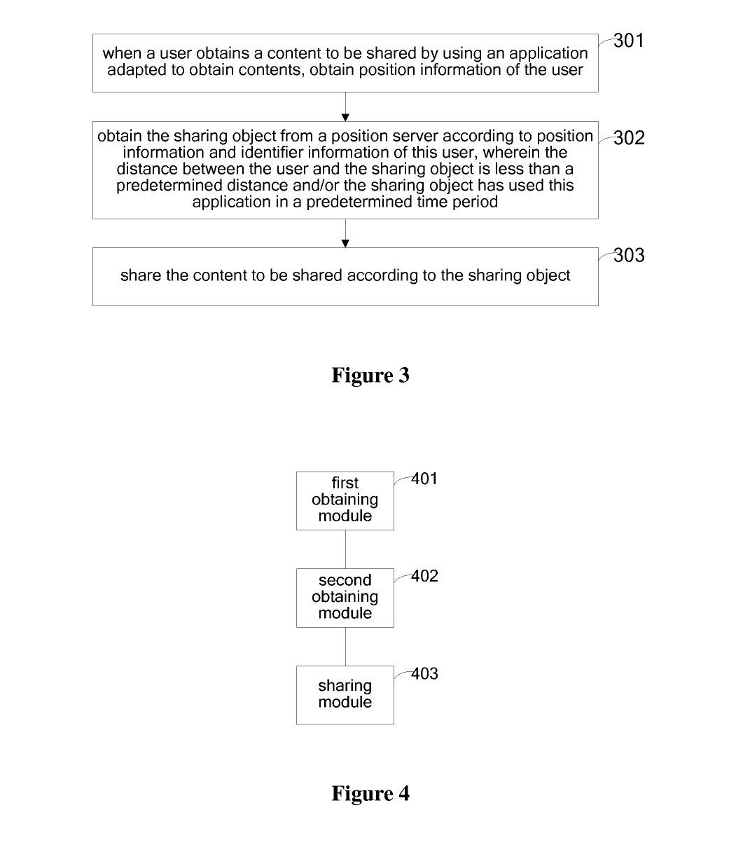

As shown in FIG. 3, an embodiment of the present invention provides a method for sharing contents, which includes the followings:

Step 301: when a user uses an application adapted to obtain contents to obtain a content to be shared, position information of the user is obtained.

Step 302: the sharing object(s) is obtained from a position server according to the position information and identifier information of this user, where the distance between the user and any of the sharing object(s) is less than a predetermined distance and/or any of the sharing object(s) has used this application in a predetermined time period.

Step 303: the content to be shared is shared according to the sharing object.

The executive entity in this embodiment may be a terminal.

In the embodiment of the present invention, the terminal obtains the position information of the user, and obtains object(s) from the position server according to the position information and identifier information of a user, where the distance between the user and any of the sharing object(s) is less than a predetermined distance and/or any of the sharing object(s) has used this application in a predetermined time period, and the terminal shares the content to be shared according to the sharing object(s). In the embodiment, the distance between the user and any of the sharing object(s) is less than the predetermined distance, and both of the sharing object(s) and the user have used the application in a predetermined time period to obtain the content, thereby improving the interactivity between the user and the sharing object(s). In addition, the object list can be automatically obtained for the user so as to facilitate the user's operation.

### Embodiment 4

As shown in FIG. 4, an embodiment of the present invention provides a terminal, which includes the followings:

A first obtaining module 401, adapted for obtaining position information of a user when the user uses an application adapted to obtain contents to obtain a content to be shared;

A second obtaining module 402, adapted for obtaining the sharing object(s) from a position server according to the position information and identifier information of this user, wherein the distance between the user and any of the sharing object(s) is less than a predetermined distance and/or any of the sharing object(s) has used this application in a predetermined time period; and

A sharing module 403, adapted for sharing the content to be shared according to the sharing object (s).

The first obtaining module 401 includes one of the following units:

A positioning unit, adapted for positioning the terminal by using a GPS module included in the terminal to obtain the position coordinates of the terminal, and taking the position coordinates of the terminal as the position information of this user;

A first obtaining unit, adapted for obtaining identifier information of a base station to which the terminal accesses, and taking the identifier information of the base station as the position information of this user; and

A second obtaining unit, adapted for obtaining identifier information of a wifi network to which the terminal accesses, and taking the identifier information of the wifi network as the position information of this user.

The second obtaining module 402 includes the followings:

A sending unit, adapted for sending a reporting request massage carrying the position information and the identifier information of the user to the position server to enable the position server to obtain an object list according to the position information and the identifier information of the user, wherein the object list includes identifier information of the sharing object(s); and

A receiving unit, adapted for receiving the reporting response massage sent by the position server, wherein the reporting request massage carries the object list.

The sharing module 403 includes the followings:

A display unit, adapted for displaying the identifier information of the sharing object(s) included in the object list to the user;

A deleting unit, adapted for deleting the identifier information of a sharing object selected by this user from the object list on the condition that this user selects from the object list the identifier information of the sharing object to be deleted;

An adding unit, adapted for obtaining identifier information of a new sharing object and adding the identifier information of the new sharing object into the object list on the condition that this user wants to add the new sharing object into the object list; and

A sharing unit, adapted for sharing the content to be shared with the sharing object(s) according to the identifier information of the sharing object(s) included in the object list.

In the embodiment of the present invention, a reporting request massage is received from a terminal, sharing object(s) is obtained according to the position information and identifier information of a user carried in the reporting request massage, where the distance between the user and any of the sharing object(s) is less than a predetermined distance and/or any of the sharing object(s) has used this application in a predetermined time period, and a reporting response massage is sent to the terminal to enable the terminal to share the content to be shared with the sharing object(s). In the embodiment, the distance between the user and any of the sharing object(s) is less than the predetermined distance, and both of the sharing object(s) and the user have used the application in a predetermined time period to obtain the content, thereby improving the interactivity between the user and the sharing object(s). In addition, the object list can be automatically obtained for the user so as to facilitate the user's operation.

### Embodiment 5

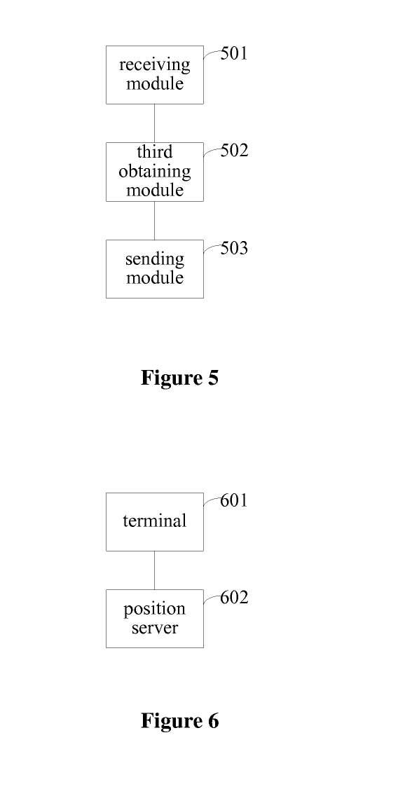

As shown in FIG. 5, an embodiment of the present invention provides a terminal, which includes the followings:

A receiving module 501, adapted for receiving a reporting request massage sent by a terminal when a user uses an application adapted to obtain contents to obtain a content to be shared, where the reporting request massage carries position information and identifier information of the user;

A third obtaining module 502, adapted for obtaining the sharing object(s) according to the position information and identifier information of the user, wherein the distance between the user and any of the sharing object(s) is less than a predetermined distance and/or any of the sharing object(s) has used this application in a predetermined time period; and

A sending module 503, adapted for sending a reporting response massage carrying the sharing object(s) to the terminal to enable the terminal to share the content to be shared according to the sharing object(s).

The third obtaining module 502 includes the followings:

A third obtaining unit, adapted for obtaining position coordinates of the user according to the position information of the user; and

A fourth module unit, adapted for obtaining the object list according to a stored correspondence relationship between the identifier information and position coordinates of users as well as the identifier information and position coordinates of this user, where the object list includes the identifier information of the sharing object(s) and the distance between any of the sharing object(s) and this user is less than a predetermined distance.

The third obtaining unit includes the followings:

A determining subunit, adapted for taking the position coordinates of the terminal as the position coordinates of the user on the condition that the position information of the user is the position coordinates of the terminal;

A first obtaining subunit, adapted for, one the condition that the position information of the user is identifier information of a base station, obtaining position coordinates of the base station from a stored correspondence relationship between the identifier information and the position coordinates of base stations according to identifier information of this base station, and taking the position coordinates of this base station as the position coordinates of this user; and

A second obtaining subunit, adapted for, on the condition that the position information of the user is identifier information of a wifi network, obtaining according to identifier information of the wifi network, position coordinates of the wifi network from a stored correspondence relationship between the identifier information and the position coordinates of wifi networks, and taking the position coordinates of the wifi network as the position coordinates of this user.

The third obtaining module 502 may further include a removing unit, adapted for obtaining usage time when the sharing object(s) included in the object list lately uses the application, and removing, according to the usage time, the identifier information of sharing object(s) which has not used the application within a predetermine time period from the object list.

Further, the server may further include an establishment unit, adapted for establishing a correspondence relationship between the identifier information and the position coordinates of the user.

In the embodiment of the present invention, a reporting request massage is received from a terminal, sharing object(s) is obtained according to the position information and identifier information of a user carried in the reporting request massage, where the distance between the user and any of the sharing object(s) is less than a predetermined distance and/or any of the sharing object(s) has used this application in a predetermined time period, and a reporting response massage is sent to the terminal to enable the terminal to share the content to be shared with the sharing object(s). In the embodiment, the distance between the user and any of the sharing object(s) is less than the predetermined distance, and both of the sharing object(s) and the user have used the application in a predetermined time period to obtain the content, thereby improving the interactivity between the user and the sharing object(s). In addition, the object list can be automatically obtained for the user so as to facilitate the user's operation.

### Embodiment 6

As shown in FIG. 6, an embodiment of the present invention provides a system for sharing contents, which include a terminal 601 as described in Embodiment 4 and a position server 602 as described in Embodiment 5.

Those skilled in the art should be understand that all or a part of the above embodiments may be completed by using hardware, or be implemented by using a program which send instructions to the hardware to complete these embodiments. The program may be stored in a computer-readable storage medium, and the flow chart of the embodiments as described in the above various methods may be performed when the program is executed. The above mentioned storage medium may be Read-Only Memory (ROM), magnetic disc, optical disc, Random Access Memory (RAM) or the like.

The forgoing is only preferred embodiments of the present invention, and is not intended to limit the present invention. Any modifications, equivalents, improvements and the like made within the spirit and principle of the present application should be encompassed in the protection scope of the present application.

1-4. (canceled)

5. A method for sharing contents, characterized by comprising:
receiving a reporting request massage sent by a terminal when an application adapted to obtain contents is used to obtain a content to be shared, wherein the reporting request massage carries position information and identifier information of a user;
obtaining a sharing object according to the position information and the identifier information of the user, wherein the distance between the user and the sharing object is less than a predetermined distance and/or the sharing object has used the application in a predetermined time period; and
sending a reporting response massage carrying the sharing object to the terminal to enable the terminal to share the content to be shared according to the sharing object.

6. The method for sharing contents according to claim 5, characterized in that, a process of obtaining a sharing object according to the position information and the identifier information of the user comprises:
obtaining position coordinates of the user according to the position information of the user; and
obtaining an object list according to the identifier information and the position coordinates of the user as well as a stored correspondence relationship between identifier information and the position coordinates of users, wherein the object list comprises identifier information of a sharing object and the distance between the sharing object and the user is less than a predetermined distance.

7. The method for sharing contents according to claim 6, characterized in that, a process of obtaining position coordinates of the user according to the position information of the user comprises:
taking position coordinates of the terminal as the position coordinates of the user on the condition that the position information of the user is the position coordinates of the terminal;
on the condition that the position information of the user is identifier information of a base station, obtaining, according to the identifier information of the base station, position coordinates of the base station from a stored correspondence relationship between identifier information and the position coordinates of base stations, and taking the position coordinates of the base station as the position coordinates of the user; and
on the condition that the position information of the user is identifier information of a wifi network, obtaining, according to the identifier information of the wifi network, position coordinates of the wifi network from a stored correspondence relationship between identifier information and the position coordinates of the wifi networks, and taking the position coordinates of the wifi network as the position coordinates of the user.

8. The method for sharing contents according to claim 6, characterized in that, after obtaining an object list according to the identifier information and the position coordinates of the user as well as a stored correspondence relationship between identifier information and the position coordinates of users, the method further comprises:
obtaining usage time when the sharing object in the object list lately uses the application, and removing from the object list the identifier information of the sharing object which has not used the application within a predetermine time period according to the usage time.

9. The method for sharing contents according to claim 6, characterized in that, after obtaining position coordinates of the user according to the position information of the user, the method further comprises:
establishing a correspondence relationship between the identifier information of the user and the position coordinates of the user.

10-13. (canceled)

14. A position server, characterized in that, the position server comprises:
a receiving module, adapted for receiving a reporting request massage sent by a terminal when an application adapted to obtain contents is used to obtain a content to be shared, wherein the reporting request massage carries position information and identifier information of a user;
a third obtaining module, adapted for obtaining a sharing object according to the position information and the identifier information of the user, wherein the distance between the user and the sharing object is less than a predetermined distance and/or the sharing object has used the application in a predetermined time period; and
a sending module, adapted for sending a reporting response massage carrying the sharing object to the terminal to enable the terminal to share the content to be shared according to the sharing object.

15. The position server according to claim 14, characterized in that, the third obtaining module comprises:
a third obtaining unit, adapted for obtaining position coordinates of the user according to the position information of the user; and
a fourth module unit, adapted for obtaining an object list according to the identifier information and the position coordinates of the user as well as a stored correspondence relationship between identifier information and the position coordinates of users, wherein the object list comprises identifier information of a sharing object and the distance between the sharing object and the user is less than a predetermined distance.

16. The position server according to claim 15, characterized in that, the third obtaining unit comprises:
a determining subunit, adapted for taking the position coordinates of the terminal as the position coordinates of the user one the condition that the position information of the user is the position coordinates of the terminal;
a first obtaining subunit, adapted for, on the condition that the position information of the user is identifier information of a base station, obtaining, according to the identifier information of the base station, position coordinates of the base station from a stored correspondence relationship between identifier information and the position coordinates of base stations, and taking the position coordinates of the base station as the position coordinates of the user; and
a second obtaining subunit, adapted for, on the condition that the position information of the user is identifier information of a wifi network, obtaining, according to the identifier information of the wifi network, position coordinates of the wifi network from a stored correspondence relationship between identifier information and the position coordinates of the wifi networks, and taking the position coordinates of the wifi network as the position coordinates of the user.

17. The position server according to claim 15, characterized in that, the third obtaining unit further comprises:
a removing unit, adapted for obtaining usage time when the sharing object in the object list lately uses the application, and removing from the object list the identifier information of the sharing object which has not used the application within a predetermine time period according to the usage time.

18. The position server according to claim 15, characterized in that, the position server further comprises:
an establishment unit, adapted for establishing a correspondence relationship between the identifier information of the user and the position coordinates of the user.

19. A system for sharing contents, characterized in that, the system comprises a terminal and the position server according to claim 14;
the terminal comprises:
a first obtaining module, adapted for obtaining position information of a user when an application adapted to obtain contents is used to obtain a content to be shared;
a second obtaining module, adapted for obtaining a sharing object from a position server according to the position information of the user and identifier information of the user, wherein the distance between the user and the sharing object is less than a predetermined distance and/or the sharing object has used the application in a predetermined time period; and
a sharing module, adapted for sharing the content to be shared according to the sharing object.

20-23. (canceled)

24. One or more computer storage mediums comprising computer-executable instructions, wherein the computer-executable instructions are adapted to perform a method for sharing contents, characterized in that, the method comprises the following steps:
receiving a reporting request massage sent by a terminal when an application adapted to obtain contents is used to obtain a content to be shared, wherein the reporting request massage carries position information and identifier information of a user;
obtaining a sharing object according to the position information and the identifier information of the user, wherein the distance between the user and the sharing object is less than a predetermined distance and/or the sharing object has used the application in a predetermined time period; and
sending a reporting response massage carrying the sharing object to the terminal to enable the terminal to share the content to be shared according to the sharing object.

25. The computer storage medium according to claim 24, characterized in that, a process of obtaining a sharing object according to the position information and the identifier information of the user comprises:
obtaining position coordinates of the user according to the position information of the user; and
obtaining an object list according to the identifier information and the position coordinates of the user as well as a stored correspondence relationship between identifier information and the position coordinates of users, wherein the object list comprises identifier information of a sharing object and the distance between the sharing object and the user is less than a predetermined distance.

26. The computer storage medium according to claim 25, characterized in that, a process of obtaining position coordinates of the user according to the position information of the user comprises:
taking the position coordinates of the terminal as the position coordinates of the user one the condition that the position information of the user is the position coordinates of the terminal;
on the condition that the position information of the user is identifier information of a base station, obtaining, according to the identifier information of the base station, position coordinates of the base station from a stored correspondence relationship between identifier information and the position coordinates of base stations, and taking the position coordinates of the base station as the position coordinates of the user; and
on the condition that the position information of the user is identifier information of a wifi network, obtaining, according to the identifier information of the wifi network, position coordinates of the wifi network from a stored correspondence relationship between identifier information and the position coordinates of the wifi networks, and taking the position coordinates of the wifi network as the position coordinates of the user.

27. The computer storage medium according to claim 25, characterized in that, after obtaining an object list according to the identifier information and the position coordinates of the user as well as a stored correspondence relationship between identifier information and the position coordinates of users, the method further comprises:
obtaining usage time when the sharing object in the object list lately uses the application, and removing from the object list the identifier information of the sharing object which has not used the application within a predetermine time period according to the usage time.

28. The computer storage medium according to claim 25, characterized in that, after obtaining position coordinates of the user according to the position information of the user, the method further comprises:
establishing a correspondence relationship between the identifier information of the user and the position coordinates of the user.
